(19) United States
(12) Patent Application Publication
(10) Pub. No.: US 2018/0107713 A1
(43) Pub. Date: Apr. 19, 2018

(54) ADAPTIVE QUERY ROW SELECTION

(71) Applicant: International Business Machines Corporation, Armonk, NY (US)

(72) Inventors: Craig S. ALDRICH, Rochester, MN (US); Rafal P. KONIK, Oronoco, MN (US); Roger A. MITTELSTADT, Byron, MN (US); Brian R. MURAS, Otsego, MN (US); Jane A. VOLD, Byron, MN (US)

(21) Appl. No.: 15/293,201

(22) Filed: Oct. 13, 2016

(51) Int. Cl. G06F 17/30

(52) U.S. Cl. CPC G06F 17/30463; G06F 17/30477; G06F 17/30448; G06F 17/30554

(57) ABSTRACT

Method, apparatus and article of manufacture for managing query execution. A query is received from a requesting entity for execution against a database. Embodiments execute the query to produce a set of query results, by initiating execution of a query plan for the query, catching, via an exception handler, a first one or more exceptions occurring while determining a first one or more query result rows and, after catching the first one or more exceptions, continuing execution of the query plan to produce an initial set of query results. The first one or more query result rows are added to an end of the initial set of query results, to produce the set of query results and the set of query results is returned to the requesting entity, where at least one erroneous query result row that was not omitted is appended to the end of the query results.

### BACKGROUND

The invention relates to database management systems, and in particular, to managing exceptions occurring during query execution using adaptive query row selection.

Databases are used to store information for an innumerable number of applications, including various commercial, industrial, technical, scientific and educational applications. As the reliance on information increases, both the volume of information stored in most databases, as well as the number of users wishing to access that information, likewise increases. Moreover, as the volume of information in a database, and the number of users wishing to access the database, increases, the amount of computing resources required to manage such a database increases as well.

Database management systems (DBMS's), which are the computer programs that are used to access the information stored in databases, therefore often require tremendous resources to handle the heavy workloads placed on such systems. As such, significant resources have been devoted to increasing the performance of database management systems with respect to processing searches, or queries, to databases.

Improvements to both computer hardware and software have improved the capacities of conventional database management systems. For example, in the hardware realm, increases in microprocessor performance, coupled with improved memory management systems, have improved the number of queries that a particular microprocessor can perform in a given unit of time. Furthermore, the use of multiple microprocessors and/or multiple networked computers has further increased the capacities of many database management systems.

From a software standpoint, the use of relational databases, which organize information into formally-defined tables consisting of rows and columns, and which are typically accessed using a standardized language such as Structured Query Language (SQL), has substantially improved processing efficiency, as well as substantially simplified the creation, organization, and extension of information within a database. Furthermore, significant development efforts have been directed toward query “optimization”, whereby the execution of particular searches, or queries, is optimized in an automated manner to minimize the amount of resources required to execute each query.

### SUMMARY

One embodiment of the present disclosure provides a method that includes receiving, from a requesting entity, a query for execution against a database. The method includes executing the query to produce a set of query results, by initiating execution of the query, catching, via an exception handler, a first one or more exceptions occurring while determining a first one or more query result rows, after catching the first one or more exceptions, and continuing execution of the query to produce an initial set of query results. The method includes adding the first one or more query result rows to an end of the initial set of query results, to produce the set of query results. The method also includes returning the set of query results to the requesting entity.

Another embodiment of the present invention provides a system, that includes a processor and a memory storing computer program code that, when executed by operation of the processor, performs an operation. The operation includes receiving, from a requesting entity, a query for execution against a database. The operation includes executing the query to produce a set of query results, by initiating execution of the query, catching, via an exception handler, a first one or more exceptions occurring while determining a first one or more query result rows, and, after catching the first one or more exceptions, continuing execution of the query to produce an initial set of query results. The operation includes adding the first one or more query result rows to an end of the initial set of query results, to produce the set of query results. The operation also includes returning the set of query results to the requesting entity.

Yet another embodiment of the present disclosure provides a computer-readable storage medium containing computer program code that, when executed by operation of one or more computer processors, performs an operation. The operation includes receiving, from a requesting entity, a query for execution against a database. The operation includes executing the query to produce a set of query results, by initiating execution of the query, catching, via an exception handler, a first one or more exceptions occurring while determining a first one or more query result rows, and, after catching the first one or more exceptions, continuing execution of the query to produce an initial set of query results. The operation includes adding the first one or more query result rows to an end of the initial set of query results, to produce the set of query results. The operation also includes returning the set of query results to the requesting entity.

BRIEF DESCRIPTION OF THE SEVERAL VIEWS OF THE DRAWINGS

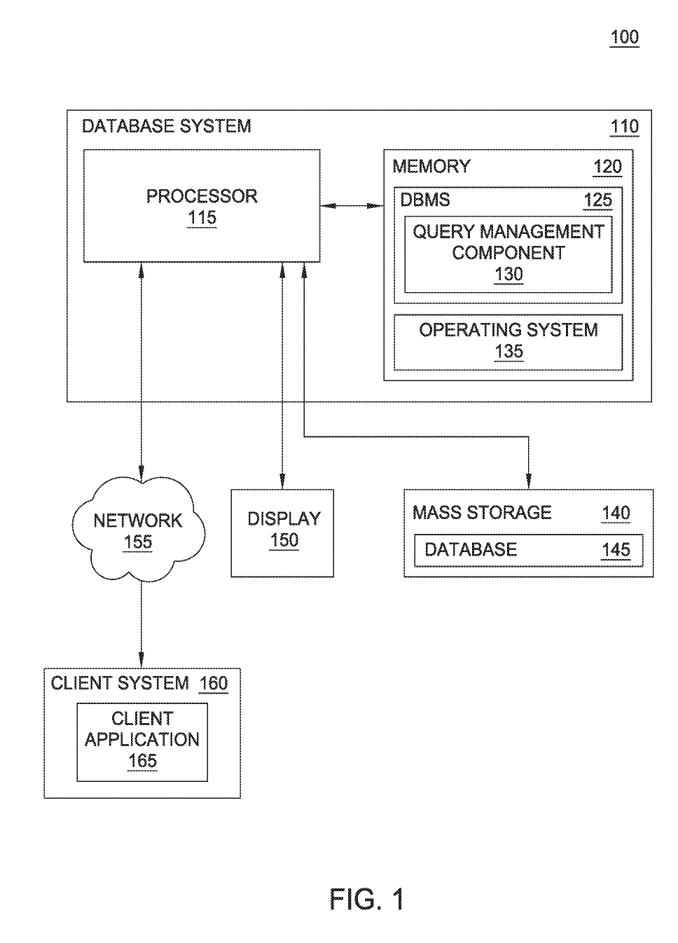

FIG. 1 is a block diagram illustrating a database system configured with a query management component, according to one embodiment described herein.

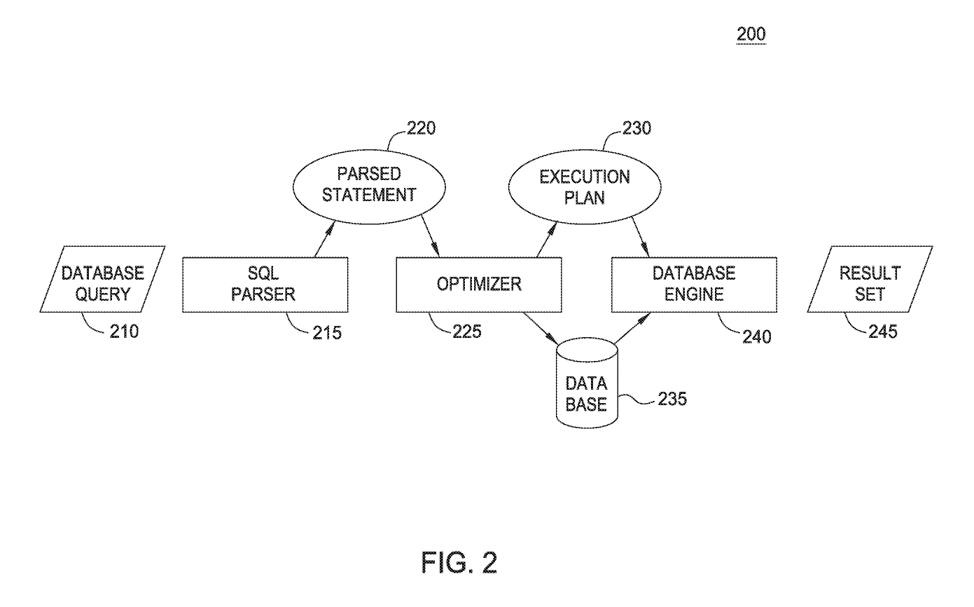

FIG. 2 is a flow diagram for processing a database query, according to one embodiment described herein.

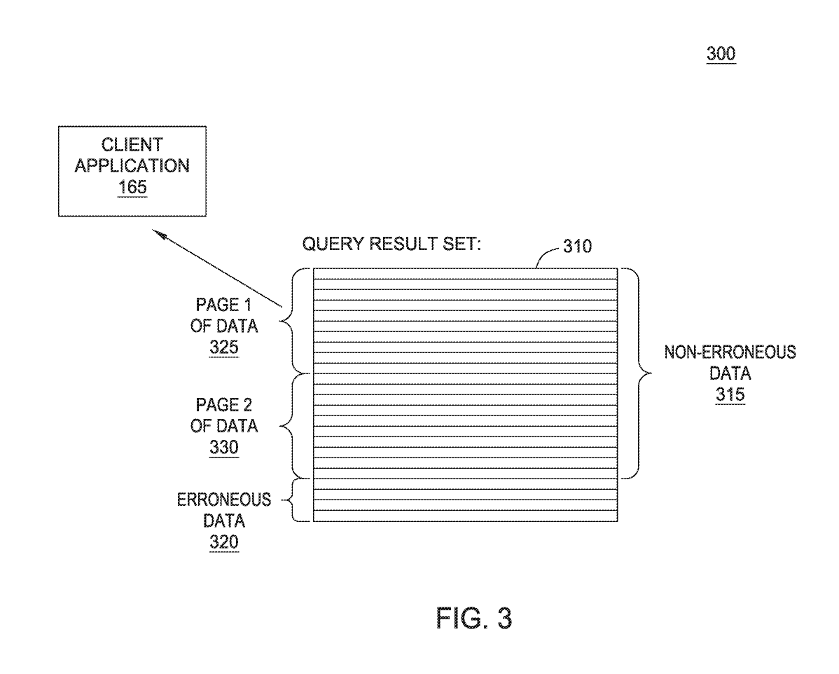

FIG. 3 illustrates query results processed by a query management component, according to one embodiment described herein.

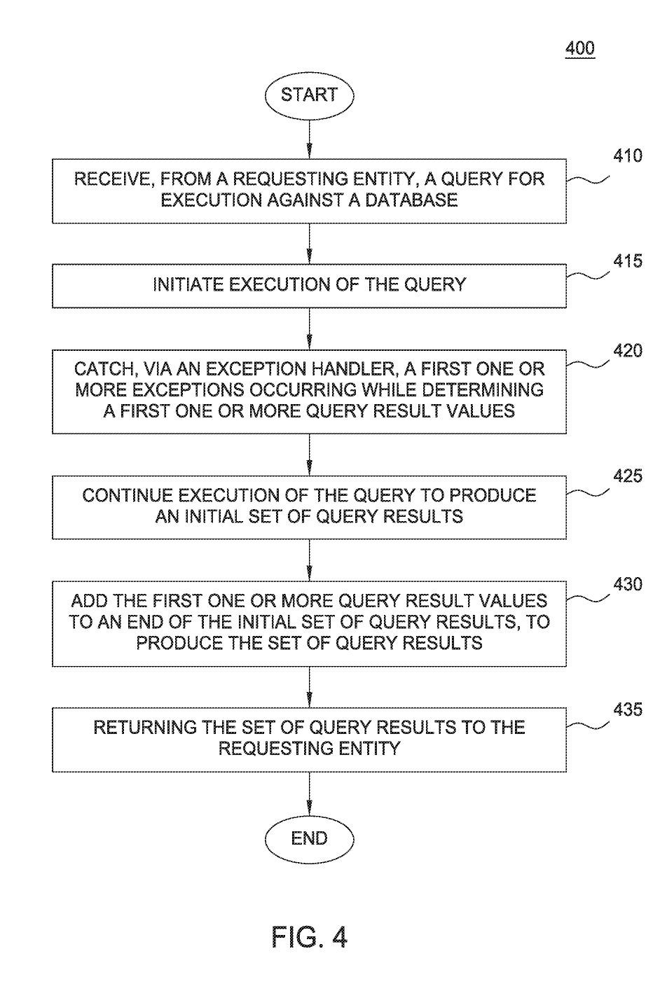

FIG. 4 is a flow diagram illustrating a method of handling exceptions thrown during the processing of a query, according to one embodiment described herein.

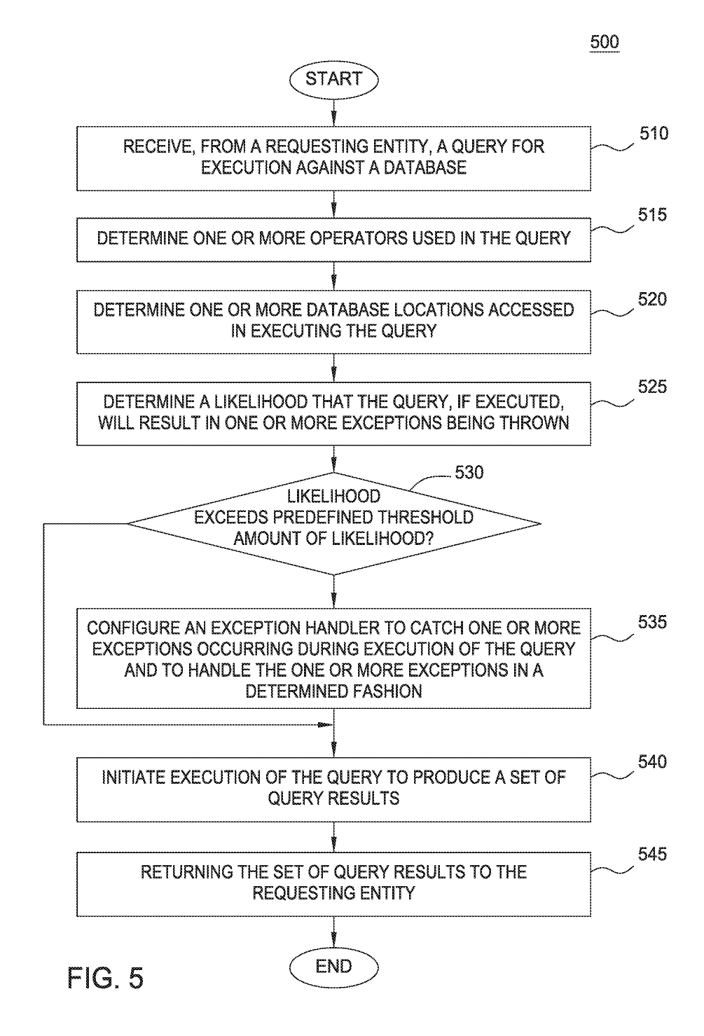

FIG. 5 is a flow diagram illustrating a method of managing execution a query based on a determined likelihood of an exception being thrown during execution of the query, according to one embodiment described herein.

### DETAILED DESCRIPTION

Typically, executing a database query involves performing a set of input and output operations (e.g., on a database table). Moreover, in executing a database query, one or more data processing operations can be performed on values retrieved from the database (e.g., a division operation could be performed using one or more values retrieved from a column within a table of the database). In doing so, data mapping errors can occurring during the execution of the query. For example, an exception could be thrown during the processing of a particular database table, and such an exception in a conventional DBMS could result in the termination of the read/write buffer processing for the table (as well as an error message being returned to the DBMS and, potentially, to the client submitting the database query).

Generally, such an exception could be thrown for a variety of reasons. For example, a database table being accessed by the query could contain bad data (e.g., misformed data), such as an improperly formed data field (e.g., a data value having an improper format for a date field, a data value having values outside of the fixed range for a date field, character data values being written to a decimal data type field, etc.). As another example, a data processing operation performed in executing the query could result in the exception being thrown. For instance, a query could specify that a division operation should be performed using values retrieved from a particular database column, and such a database column could contain one or more values that result in an exception being thrown. As an example, a query of “SELECT 10/FLD1 FROM TBL1”, where FLD1 contains a zero value, could result in a division by zero operation being performed, which in turn could result in an exception being thrown during the execution of the query. As an additional example, a query could result in a mathematic overflow error which in turn could result in one or more exceptions being thrown during the execution of the query.

In practice, such exceptions being thrown during query execution can result in reduced performance of an application that is submitting the query to the DBMS, as well as one or more error messages being displayed during the execution of the application. Such errors can result in customer complaints, problem management reports (PMRs) being submitted), and discussion items (DIs) being created for data mapping or selection errors (e.g., where the customer did not receive such errors in a previous release of the DBMS, or when the errors otherwise seem to appear without a reason). While such errors can appear to arise suddenly and to be indicative of a problem with the DBMS itself, many times these errors are actually caused by misformed or otherwise erroneous data within the database itself, rather than a problem with the DBMS.

Additionally, in many instances, a set of query results may include only a few erroneous values, while the vast majority of the values within the query results may be valid. In conventional systems, an error occurring during the processing of any of the query result rows (e.g., an exception being thrown when attempting to generate a particular query result row) can terminate the execution of the query altogether, and the DBMS can return an error message to the party submitting the query, in lieu of any query results. However, in many instances, a user may be willing to accept a partial set of query results that includes only the non-erroneous query result rows.

As such, embodiments provide techniques for managing the execution of a query in a manner that accounts for an exception being thrown during execution of the query. In one embodiment, a DBMS configured with a query management component receives, from a requesting entity, a query for execution against a database. The query management component then executing the query to produce a set of query results. In executing the query, the query management component can initiate execution of a query plan, catching, via an exception handler, a first one or more exceptions occurring while determining a first one or more query result rows, and add the first one or more query result rows to an end of a working set of query results. The query management component can then continue execution of the query plan to produce the set of query results, and the query management component can return the set of query results to the requesting entity. Doing so enables the query management component to more gracefully handle errors occurring during execution of the query and to return at least a partial query result set to the user, in the event of an error occurring during query execution.

FIG. 1 is a block diagram illustrating a database system configured with a query management component, according to one embodiment described herein. Generally, system 100 represents practically any type of computer, computer system or other programmable electronic device, including a client computer, a server computer, a portable computer, a handheld computer, an embedded controller, etc. Moreover, the system 100 may be implemented using one or more networked computers, e.g., in a cluster or other distributed computing system.

System 100, as shown, includes a database system 110 and a client system 160, interconnected via network 155. The client system 160 includes a client application 165. Additionally, database system 110 is communicatively coupled to a display device 150 and a mass storage device 140. The database system 110, as shown, includes at least one processor 115 coupled to a memory 120. Processor 115 may represent one or more processors (e.g., microprocessors), and memory 120 may represent the random access memory (RAM) devices comprising the main storage of the database system 110, as well as any supplemental levels of memory, e.g., cache memories, non-volatile or backup memories (e.g., programmable or flash memories), read-only memories, etc. In addition, memory 120 may be considered to include memory storage physically located elsewhere in system 100, e.g., any cache memory in a processor 115, as well as any storage capacity used as a virtual memory, e.g., as stored on a mass storage device 140 or on another computer coupled to system 100 via network 155 (e.g., a client computer 160).

Generally, the database system 110 typically receives a number of inputs and outputs for communicating information externally. For interface with a user or operator, the database system 110 typically includes one or more user input devices (e.g., a keyboard, a mouse, a trackball, a joystick, a touchpad, and/or a microphone, among others) and provides a graphical user interface via display device 150 (e.g., a CRT monitor, an LCD display panel, among others). Otherwise, user input may be received via another computer interfaced with the database system 110 (e.g., over network 155), or via a dedicated workstation interface or the like.

For additional storage, the database system 110 is configured to interface with mass storage device 140, e.g., a hard disk drive, a direct access storage device (DASD), an optical drive (e.g., a CD drive, a DVD drive, etc.), and/or a tape drive, among others. The network 155 generally represents any data communications network (e.g., a LAN, a WAN, a wireless network, and/or the Internet, among others) and generally permits electronic communication of information between the database system 110 and other computers coupled to the network 155 (e.g., client system 160). It should be appreciated that database system 110 may also include suitable analog and/or digital interfaces (not shown) between processor 115 and each of components (e.g., network 155, display 150, etc.).

As shown, the memory 120 includes a Database Management System (DBMS) 125 and an operating system 135. Generally, the database system 110 operates under the control of the operating system 135, and executes or otherwise relies upon various computer software applications, components, programs, objects, modules, data structures, etc. The DBMS 125 is configured with a query management component 130. Generally, the DBMS 125 facilitates the creation and management of the database 145. For example, the DBMS 125 could provide an Application Program Interface (API) through which remote clients (e.g., the client application 165 on the client system 160) can submit requests (e.g., database queries). For example, the client application 165 could submit a database query to retrieve particular values from the database 145. The DBMS 125 could execute the database query against the database 145 to produce a set of query results and could return the set of query results to the client application 165 (e.g., over network 155).

As discussed above, one or more exceptions can be thrown during the execution of a query by the DBMS 125. For example, a query could specify that a division operation should be performed using values within a particular column of a table in the database 145 as the denominator. However, if such a column contains a value of “0”, an exception may be thrown when the DBMS 125 attempts to perform a division by zero operation. Conventionally, such an exception being thrown would result in the DBMS 125 halting the execution of the query, discarding any query results determined thus far during the partial execution of the query and returning an error message to the client application 165.

Generally, the query management component 130 is configured to manage the execution of queries and to improving the DBMS' handling of errors that occur during query execution. In one embodiment, the query management component 130 receives, from a requesting entity, a query for execution against a database. For example, the query management component 130 could receive a query over the network 155 from the client application 165 executing on the client system 160.

The query management component 130 initiates execution of a query plan for the query. During execution of the query plan, the query management component 130 can catch, via an exception handler, a first one or more exceptions occurring while determining a first one or more query result rows. For example, in attempting to determine the one or more query result rows, the query management component 130 could catch an exception occurring during an attempted division by zero operation. Upon catching the exception, the query management component 130 could add the first one or more query result rows (or, e.g., an error message resulting from attempting to calculate the query result rows) to an end of the initial set of query results. The query management component 130 could then continue executing the query plan to produce the set of query results and could return the set of query results to the requesting entity. By doing so, the query management component 130 ensures that the execution of the query plan finishes to completion (e.g., rather than aborting due to the exception(s) thrown during execution), and moreover prioritizes the ordering of the values within the set of query results to reduce the likelihood that the requesting entity (e.g., client application 165) needs to process the erroneous query result rows. For example, the query management component 130 could add the erroneous query result rows to a second page of the set of query results, and the client application 165 may only need to process the first page of query results, thereby avoiding processing the erroneous query result rows.

FIG. 2 is a flow diagram for processing a database query at a database management system, according to one embodiment described herein. As shown in the flow diagram 200, the DBMS 125 receives a database query 210 from a requesting entity. In the depicted embodiment, the received query is processed by a Structured Query Language (SQL) parser 215 to generate the parsed statement 220. The parsed statement 220 is passed to an optimizer component 225 for query optimization. As a result of query optimization, an execution plan 230 (also referred to herein as an access plan or a query plan) is generated, often using data such as platform capabilities, query content information, etc., that is stored in database 235. Once generated, the execution plan 230 is forwarded to database engine 240 for execution on the information in database 235. The result of the execution of the database query is typically stored in a result set 245, which can then be returned to the requesting entity. Other components may be incorporated into the DBMS, as may other suitable database management architectures. Other database programming and organizational architectures may also be used consistent with the invention. Therefore, the present is not limited to the particular implementation discussed herein.

In the diagram 200, the database engine 240 could be configured with the query management component 130 and could initiate execution of the execution plan for the query. During execution of the execution plan, the query management component 130 can catch, via an exception handler, a first one or more exceptions occurring while determining a first one or more query result rows. For example, in attempting to determine the one or more query result rows, the query management component 130 could catch an exception occurring during an attempted division by zero operation. Generally, a number of different scenarios can result in an exception being thrown during query execution. For example, and without limitation, invalid data could be stored in a field used in a query (e.g., non-decimal data stored in a decimal field), a significant digit within a data value could have been truncated, a floating point value could exceed the maximum representable value, a floating point value could be less than the minimum representable value, etc. More generally, the query management component 130 can be configured to handle any exception thrown during the execution of a query, consistent with the functionality described herein.

Upon catching the exception, the query management component 130 could concatenate the first one or more query result rows (or, e.g., an error message or fault code) to an end of the initial set of query results. The query management component 130 could then continue executing the query plan to produce the set of query results and could return the set of query results to the requesting entity. Doing soensures that the execution of the query plan finishes to completion and does not abort part-way through execution due to an exception being thrown.

An example of such query results are shown in FIG. 3, which illustrates query results processed by a query management component, according to one embodiment described herein. As shown, the illustration 300 depicts a set of query results 310 being returned to a client application 165. The set of query results 310 is divided into pages 325, 330 and 320, where the pages 325 and 330 contain non-erroneous data 315 and the erroneous data 320 is contained on the final page of the query result set 310. In many instances, the client application 165 may only use a portion of the query results (e.g., pages 325 and 330) and by placing the erroneous data 320 at the end of the set of query results 310, embodiments can, in many situations, avoid the client application 165 encountering the erroneous data 320 whatsoever. Moreover, by handling the exceptions thrown during the execution of the query more gracefully than conventional solutions (which typically aborted execution of the query altogether and returned an error message), the query management component 130 allows the non-erroneous data 315 to be returned to the client application 165.

In one embodiment, the query management component 130 is configured to re-order the query results as shown in FIG. 3, unless the requesting entity has specified that a particular ordering for the query result rows. In other words, if the query specifies that the query result rows should be sorted in a particular arrangement, the query management component 130 may abstain from placing the erroneous data 320 at the end of the set of query results 310, as to do so could preclude the query result rows from being in the particular arrangement. In such a situation, the query management component 130 may handle the erroneous query result rows in an alternate manner. For example, where the requesting entity has indicated that erroneous rows may be discarded, the query management component 130 could remove the erroneous data 320 altogether. As another example, the query management component 130 could replace at least one value with each of the erroneous rows with a predefined value indicating that an error occurred when generating the query result row.

FIG. 4 is a flow diagram illustrating a method of handling exceptions thrown during the processing of a query, according to one embodiment described herein. As shown, the method 400 begins at block 410, where the query management component 130 receives, from a requesting entity, a query for execution against a database. For example, the query management component 130 could be implemented within a DBMS and could receive, over a data communications network, a query for execution against a specified database.

The query management component 130 initiates execution of the query (block 415). In doing so, the query management component 130 may first generate a query plan specifying an ordered sequence of operations to perform in the execution of the query. At some point during the execution of the query. The query management component 130 catches, via an exception handler, a first one or more exceptions occurring while determining a first one or more query result rows for the query (block 420). For example, the query could specify to divide a particular value by a data value retrieved from a particular column of a table of the database, and the database could contain a value of “0” for one of the rows of the particular column of the table, resulting in a division by zero and the corresponding exception being thrown.

Upon the exception handler catching the exception, the query management component 130 continues execution of the query to produce an initial set of query results (block 425). The query management component 130 then concatenates the erroneous query result rows (that is, the query result rows corresponding to the exceptions) to the end of the initial set of query results to produce the complete set of query results (block 430). The query management component 130 returns the set of query results to the requesting entity (block 435), and the method 400 ends. By adding the erroneous query result rows onto the end of the set of query results, embodiments may effectively hide the errors occurring during query execution from the requesting entity in certain situations. For example, when the set of query results are returned as a sequence of pages, as the data values desired by the requestor may be found on the first page(s) of the query results, in which case the requestor does not interact with the erroneous query values at all.

FIG. 5 is a flow diagram illustrating a method of managing execution a query based on a determined likelihood of an exception being thrown during execution of the query, according to one embodiment described herein. As shown, the method 500 begins at block 510, where the query management component 130 receives, from a requesting entity, a query for execution against a database. The query management component 130 determines one or more operators used in the query (block 515). For example, the query management component 130 could determine that a division operation will be performed in executing the query. The query management component 130 could subsequently use such information, for example, to estimate a likelihood of the given query generating an exception during execution. For example, the query management component 130 could determine that queries including division operators are more likely to generate an exception during execution than queries that do not include a division operator (e.g., due to exceptions being thrown when a division by zero is attempted).

In the depicted embodiment, the query management component 130 further determines one or more locations accessed in execution the query (block 520). The query management component 130 determines a likelihood that the query, if executed, will result in one or more exceptions being thrown (block 525). For instance, the query management component 130 could consider a historical rate of error for queries executed against the one or more locations, and could use such information in determining the likelihood that the current query will generate an exception during execution. That is, the query management component 130 could log exceptions and metadata describing the exceptions, for use in predicting the likelihood that a future query will generate an exception during execution. Upon receiving the current query, the query management component 130 could identify historical execution data collected from queries that are significantly similar to the current query and could use such information in predicting the likelihood the current query will generate an exception.

In one embodiment, the query management component 130 is configured to consider the operators used in the query in conjunction with the one or more database locations accessed in executing the query. For example, the query management component 130 could determine that a division operator where values from a particular database location (e.g., a column of a database table) are used as the denominator is more likely to result in an exception being thrown during execution of the query. As another example, the query management component 130 could determine that a division operator where the denominator is a non-zero constant value specified in the query is less likely to generate an exception during execution of the query.

At block 530, the query management component 130 determines whether the determined likelihood exceeds a predefined threshold amount. If so, the query management component 130 configures an exception handler to catch one or more exceptions during the execution of the query and the handle the exceptions in a determined fashion (block 535). For example, the query management component 130 could configure an exception handler to save the error for the particular row, so that the error can be concatenated onto the end of the set of query results. Once the exception handler is configured, or if the query management component 130 determines at block 530 that the likelihood did not exceed the threshold, the query management component 130 initiates execution of the query to produce a set of query results (block 540). The query management component 130 then returns the set of query results to the requesting entity from which the query was received (block 545), and the method 500 ends.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

In the following, reference is made to embodiments presented in this disclosure. However, the scope of the present disclosure is not limited to specific described embodiments. Instead, any combination of the following features and elements, whether related to different embodiments or not, is contemplated to implement and practice contemplated embodiments. Furthermore, although embodiments disclosed herein may achieve advantages over other possible solutions or over the prior art, whether or not a particular advantage is achieved by a given embodiment is not limiting of the scope of the present disclosure. Thus, the following aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

Aspects of the present invention may take the form of an entirely hardware embodiment, an entirely software embodiment (including firmware, resident software, microcode, etc.) or an embodiment combining software and hardware aspects that may all generally be referred to herein as a “circuit,” “module” or “system.”

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Embodiments of the invention may be provided to end users through a cloud computing infrastructure. Cloud computing generally refers to the provision of scalable computing resources as a service over a network. More formally, cloud computing may be defined as a computing capability that provides an abstraction between the computing resource and its underlying technical architecture (e.g., servers, storage, networks), enabling convenient, on-demand network access to a shared pool of configurable computing resources that can be rapidly provisioned and released with minimal management effort or service provider interaction. Thus, cloud computing allows a user to access virtual computing resources (e.g., storage, data, applications, and even complete virtualized computing systems) in “the cloud,” without regard for the underlying physical systems (or locations of those systems) used to provide the computing resources.

Typically, cloud computing resources are provided to a user on a pay-per-use basis, where users are charged only for the computing resources actually used (e.g. an amount of storage space consumed by a user or a number of virtualized systems instantiated by the user). A user can access any of the resources that reside in the cloud at any time, and from anywhere across the Internet. In context of the present invention, a user may access applications (e.g., DBMS 125 configured with query management component 130 and hosting the database 145) or related data available in the cloud. For example, the DBMS 125 configured with the query management component 130 could execute on a computing system in the cloud and a client application could submit a query to the DBMS 125 for execution. In such a case, the query management component 130 could receive the query and could initiate execution of a query plan for the query. During execution of the query, the query management component 130 could catch, via an exception handler, a first one or more exceptions occurring while determining a first one or more query result rows. The query management component 130 could continuing execution of the query plan to produce an initial set of query results and, before returning the set of query results to the client, the query management component 130 could add the first one or more query result rows to an end of the initial set of query results. Doing so allows a user to submit a query against the database from any computing system attached to a network connected to the cloud (e.g., the Internet), and helps to ensure that the DBMS 125 can better handle any errors occurring during execution of the query.

While the foregoing is directed to embodiments of the present invention, other and further embodiments of the invention may be devised without departing from the basic scope thereof, and the scope thereof is determined by the claims that follow.

What is claimed is:

1. A method, comprising:
receiving, from a requesting entity, a query for execution against a database;
executing the query to produce a set of query results, comprising:
initiating execution of a query plan for the query;
catching, via an exception handler, a first one or more exceptions occurring while determining a first one or more query result rows;
after catching the first one or more exceptions, continuing execution of the query plan to produce an initial set of query results; and
adding the first one or more query result rows to an end of the initial set of query results, to produce the set of query results; and
returning the set of query results to the requesting entity.

2. The method of claim 1, wherein executing the query to produce the set of query results further comprises:
catching, via the exception handler, a second one or more exceptions occurring while determining a second one or more query result rows; and
determining to discard the second one or more query result rows, whereby the second one or more query result rows are not included in the set of query results returned to the requesting entity.

3. The method of claim 1, further comprising:
determining a likelihood that an access to a first table of the database, during execution of the query, will result in a second one or more exceptions being thrown; and
upon determining that the likelihood exceeds a predefined threshold level, modifying a selection predicate of the query, in a manner predetermined to reduce a likelihood of the second one or more exceptions being thrown.

4. The method of claim 3, wherein modifying the selection predicate of the query further comprises:
generating a plurality of selection predicates for the query;
determining, for each of the plurality of selection predicates, a respective likelihood that the query, if modified to include the selection predicate, will result in one or more exceptions being thrown; and
selecting one of the plurality of selection predicates, having the lowest determined likelihood.

5. The method of claim 3, wherein modifying the selection predicate of the query further comprises:
generating a respective portion of query results for each of a plurality of selection predicates, based on the received query; and
selecting one of the portions of query results for inclusion in the set of query results, based on a determined measure of error for the portion of query results.

6. The method of claim 3, wherein determining the likelihood that the access to the first table of the database, during execution of the query, will result in the second one or more exceptions being thrown, further comprises:
determining an operator for which a data processing operation will be performed in executing the query; and
determining, based on historical query execution data, a historical rate of exception generation for historical queries that include the data processing operation.

7. The method of claim 1, further comprising:
dividing the set of query results into a plurality of sequential portions, wherein a last portion of the plurality of sequential portions includes the first one or more query result rowquery result rows;
wherein returning the set of query results to the requesting entity further comprises:
returning a first portion of the plurality of sequential portions to the requesting entity; and
upon receiving a subsequent request, from the requesting entity, returning a second portion of the plurality of sequential portions to the requesting entity.

8. A system, comprising:
a processor; and
a memory storing computer program code that, when executed by operation of the processor, performs an operation comprising:
receiving, from a requesting entity, a query for execution against a database;
executing the query to produce a set of query results, comprising:
initiating execution of a query plan for the query;
catching, via an exception handler, a first one or more exceptions occurring while determining a first one or more query result rows;
after catching the first one or more exceptions, continuing execution of the query plan to produce an initial set of query results; and
adding the first one or more query result rows to an end of the initial set of query results, to produce the set of query results; and
returning the set of query results to the requesting entity.

9. The system of claim 8, wherein executing the query to produce the set of query results further comprises:
catching, via the exception handler, a second one or more exceptions occurring while sdetermining a second one or more query result rows; and
determining to discard the second one or more query result rows, whereby the second one or more query result rows are not included in the set of query results returned to the requesting entity.

10. The system of claim 8, the operation further comprising:
determining a likelihood that an access to a first table of the database, during execution of the query, will result in a second one or more exceptions being thrown; and
upon determining that the likelihood exceeds a predefined threshold level, modifying a selection predicate of the query, in a manner predetermined to reduce a likelihood of the second one or more exceptions being thrown.

11. The system of claim 10, wherein modifying the selection predicate of the query further comprises:
generating a plurality of selection predicates for the query;
determining, for each of the plurality of selection predicates, a respective likelihood that the query, if modified to include the selection predicate, will result in one or more exceptions being thrown; and
selecting one of the plurality of selection predicates, having the lowest determined likelihood.

12. The system of claim 10, wherein modifying the selection predicate of the query further comprises:
generating a respective portion of query results for each of a plurality of selection predicates, based on the received query; and
selecting one of the portions of query results for inclusion in the set of query results, based on a determined measure of error for the portion of query results.

13. The system of claim 10, wherein determining the likelihood that the access to the first table of the database, during execution of the query, will result in the second one or more exceptions being thrown, further comprises:
determining a data processing operation that will be performed in executing the query; and
determining, based on historical query execution data, a historical rate of exception generation for historical queries that include the data processing operation.

14. The system of claim 8, the operation further comprising:
dividing the set of query results into a plurality of sequential portions, wherein a last portion of the plurality of sequential portions includes the first one or more query result rows;
wherein returning the set of query results to the requesting entity further comprises:
returning a first portion of the plurality of sequential portions to the requesting entity; and
upon receiving a subsequent request, from the requesting entity, returning a second portion of the plurality of sequential portions to the requesting entity.

15. A computer-readable storage medium containing computer program code that, when executed by operation of one or more computer processors, performs an operation comprising:
receiving, from a requesting entity, a query for execution against a database;
executing the query to produce a set of query results, comprising:
initiating execution of a query plan for the query;
catching, via an exception handler, a first one or more exceptions occurring while determining a first one or more query result rows;
after catching the first one or more exceptions, continuing execution of the query plan to produce an initial set of query results; and
adding the first one or more query result rows to an end of the initial set of query results, to produce the set of query results; and
returning the set of query results to the requesting entity.

16. The computer-readable storage medium of claim 15, wherein executing the query to produce the set of query results further comprises:
catching, via the exception handler, a second one or more exceptions occurring while determining a second one or more query result rows; and
determining to discard the second one or more query result rows, whereby the second one or more query result rows are not included in the set of query results returned to the requesting entity.

17. The computer-readable storage medium of claim 15, the operation further comprising:
determining a likelihood that an access to a first table of the database, during execution of the query, will result in a second one or more exceptions being thrown; and
upon determining that the likelihood exceeds a predefined threshold level, modifying a selection predicate of the query, in a manner predetermined to reduce a likelihood of the second one or more exceptions being thrown.

18. The computer-readable storage medium of claim 17, wherein modifying the selection predicate of the query further comprises:
generating a plurality of selection predicates for the query;
determining, for each of the plurality of selection predicates, a respective likelihood that the query, if modified to include the selection predicate, will result in one or more exceptions being thrown; and
selecting one of the plurality of selection predicates, having the lowest determined likelihood.

19. The computer-readable storage medium of claim 17, wherein modifying the selection predicate of the query further comprises:
generating a respective portion of query results for each of a plurality of selection predicates, based on the received query; and
selecting one of the portions of query results for inclusion in the set of query results, based on a determined measure of error for the portion of query results.

20. The computer-readable storage medium of claim 17, wherein determining the likelihood that the access to the first table of the database, during execution of the query, will result in the second one or more exceptions being thrown, further comprises:
determining a data processing operation that will be performed in executing the query; and
determining, based on historical query execution data, a historical rate of exception generation for historical queries that include the data processing operation.
